(19) United States
(12) Patent Application Publication
(10) Pub. No.: US 2008/0117161 A1
(43) Pub. Date: May 22, 2008

(54) LIQUID CRYSTAL DISPLAY (LCD) PANEL ASSEMBLING METHOD

(76) Inventor: Chung-Ming HU, Taichung (TW)

Correspondence Address: RABIN & Berdo, PC, 1101 14TH STREET, NW, SUITE 500, WASHINGTON, DC, 20005, US

(21) Appl. No.: 11/869,430

(22) Filed: Oct. 9, 2007

(30) Foreign Application Priority Data
Nov. 17, 2006 (TW) 095142594

(51) Int. Cl. G09G 3/36

(52) U.S. Cl. 345/102; 345/87

(57) ABSTRACT

Disclosed is a liquid crystal display (LCD) panel assembling method, comprising the following steps: preparing a plurality of unitary LCD panels; and aligning or overlapping any one side edge of a unitary LCD panel with any one side edge of another unitary LCD panel, as such forming a large assembled LCD panel having smaller gaps. Also, disclosed is an LCD display, comprising a plurality of unitary LCD panels; a plurality of pixel elements; and a backlight module. In the above-mentioned structure, the respective unitary LCD panel includes a display area and a non-display area composed of a plurality of side edges. Any one side edge of the unitary LCD panel is aligned or overlapped with any one side edge of another unitary LCD panel, thus forming an assembled LCD panel having larger display area and smaller gaps in-between. In addition, also disclosed is another method of assembling the LCD panel and a display for using the same, wherein side edge corners of a plurality of unitary LCD panels are chamfered before being assembled.

### BACKGROUND OF THE INVENTION

1. Field of the Invention

The present invention relates to an LCD panel assembling method, that is capable of reducing the gap sizes between the respective constituting unitary LCD panels, thus realizing the assembly of a large-sized LCD panel.

2. The Prior Arts

Currently, the size of LCD panel that an LCD panel manufacturer is capable of mass producing is still restricted to below 100 inches. The main reason for this is due to high production cost and low production yield, hereby limiting its amount of supply. However, presently, due to the remarkable benefits of LCD panels utilized in sales promotion advertisement, the market demand for large-sized panel is ever increasing. Nevertheless, presently, there exists significant technical bottleneck in the development and manufacturing of large-sized LCD panel. Therefore, the development and manufacturing of large-sized LCD panel assembled by making use of panels of the currently available sizes is probably a most urgent and important task in this field.

In general, an LCD panel can be roughly classified as a displaying area (the screen) and a non-displaying area (side edge). Thus, if the panels are assembled side-by-side directly, then the side edges between the constituting panels tend to create evident gaps between the respective displaying areas, hereby adversely affecting the completeness of the image displayed. By way of example, on an ordinary TV wall, due to the existence of the screen side edges (including the plastic frame of TV, and the side frame of non-displaying area of LCD panel) between a unitary screen (namely, a TV frame) and the respectively adjacent screens, such that the various constituting screens are not able to form tightly together into a large-sized seamless screen, thus creating partitions of images, and seriously affecting the quality of image displayed and the visual effects sensed by a viewer. Similarly, when the respective unitary liquid crystal panels are utilized to form a large-sized panel containing a plurality of constituting liquid crystal panels, the side edges on the outskirt of the respective liquid crystal panels will result in the consequence that the adjoining panels are not able to join together seamlessly in a similar manner. As such, that is the limitation on the structure of the existing liquid crystal panels, and presently, it is also an evident shortcoming in the image display of a displayer made of the assembled panels. In case that this technical bottleneck can be broken through, then it would indeed be a great advancement in the technology of panel assembly.

Consequently, if the problem of the gap of the images displayed caused by the panel side edges can be solved properly, then the advantages of assembling the large-sized panels by making use of currently available small-sized panels are such that, in addition to its benefit of breaking through the size restrictions of the existing liquid crystal panel that can be mass-produced and reducing the production cost significantly, the assembly and transportation of the assembled panel can be carried out much more conveniently and efficiently.

### SUMMARY OF THE INVENTION

Although there are increasing demands for the large-sized bill board made of large-sized panels, and various panel manufacturers in the advertising and entertainment industries are actively engaged in the development and production of large-sized panels, however, for the panel manufacturing technology at the present stage, the production cost of single unitary large-sized panel is rather high, and its production yield is evidently low, thus it will encounter tremendous difficulties if it is actually put into mass production. In view of the shortcomings and drawbacks of the prior art, the objective of the present invention is to provide a method of assembling large-sized liquid crystal panels, including the following steps: preparing a plurality of unitary LCD panels; and aligning or overlapping any one side edge of a unitary LCD panel with any one side edge of another unitary LCD panel, thus forming an assembled LCD panel having large display areas and smaller gaps in-between.

Preferably, the above-mentioned liquid crystal panel is used to overlap another unitary liquid crystal panel laterally or longitudinally.

Preferably, the above-mentioned liquid crystal panel is used to align with another unitary liquid crystal panel laterally or longitudinally.

Preferably, the above-mentioned assembled liquid crystal panel is realized through joining and bonding the overlapped or aligned liquid crystal panel together by making use of at least a locking and holding member.

In addition, another objective of the present invention is to provide a display, including: a plurality of unitary LCD panels; a plurality of pixel elements; and a backlight module; wherein, the respective unitary LCD panel includes a display area and a non-display area composed of a plurality of side edges. Any one side edge of the unitary LCD panel is aligned or overlapped with any one side edge of another unitary LCD panel, hereby forming an assembled LCD panel having larger display area and smaller gaps in-between.

Preferably, the above-mentioned liquid crystal panel is used to overlap another unitary liquid crystal panel laterally or longitudinally.

Preferably, the above-mentioned liquid crystal panel is used to align with another unitary liquid crystal panel laterally or longitudinally.

Preferably, the above-mentioned assembled liquid crystal panel is realized through joining the overlapped or aligned liquid crystal panels by making use of at least a locking and holding member.

Moreover, the still another objective of the present invention is to provide a method of assembling large-sized liquid crystal panels, including the following steps: preparing a plurality of unitary LCD panels, chamfering its side edge corners; and aligning or overlapping any one side edge of a unitary LCD panel with any one side edge of another unitary LCD panel, thus forming an assembled LCD panel having large display areas and smaller gaps and/or smaller section differences in-between.

Preferably, the above-mentioned liquid crystal panel is used to overlap another unitary liquid crystal panel laterally or longitudinally.

Preferably, the above-mentioned liquid crystal panel is used to align with another unitary liquid crystal panel laterally or longitudinally.

Preferably, the above-mentioned assembled liquid crystal panel is realized through joining the overlapped or aligned liquid crystal panels by making use of at least a locking and holding member.

Furthermore, the still yet another objective of the present invention is to provide a display, including: a plurality of unitary LCD panels; a plurality of pixel elements; and a backlight module; wherein, the respective unitary LCD panel includes a display area and a non-display area composed of a plurality of side edges, and the corners of side edges of the unitary liquid crystal panel have been chamfered. Then, any one side edge of the unitary LCD panel is aligned or overlapped with any one side edge of another unitary LCD panel, thus forming an assembled LCD panel having large display areas with smaller gaps and/or smaller section differences in-between.

Preferably, the above-mentioned liquid crystal panel is used to overlap another unitary liquid crystal panel laterally or longitudinally.

Preferably, the above-mentioned liquid crystal panel is used to align with another unitary liquid crystal panel laterally or longitudinally.

Preferably, the above-mentioned assembled liquid crystal panel is realized through joining the overlapped or aligned liquid crystal panels by making use of at least a locking and holding member.

Summing up the above, the method of assembling large-sized liquid crystal panels and a display having such an assembled liquid crystal panel as provided by the present invention could have the benefit and advantage of increased image displaying area, reduced gap of the assembled panel, and eliminating the partitions of images. Meanwhile, since the large-sized assembled liquid crystal panel is realized through utilizing panels of currently available sizes, thus it has enormous cost-effectiveness advantages in consideration of market risk. As such, it has great potential and good prospect for further development in this field.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The related drawings in connection with the detailed description of the present invention to be made later are described briefly as follows, in which:

FIG. 1 is a perspective view of overlapping of liquid crystal panels with their side edges according to an embodiment of the present invention;

FIG. 2 is a schematic diagram of a display having assembled panels according to an embodiment of the present invention;

FIG. 3 is a cross section view indicating the overlapping, locking and bonding of two adjacent overlapping panels according to an embodiment of the present invention;

FIG. 4 is a schematic diagram of joining and bonding adjacent panels together through side edges of chamfered corners according to another embodiment of the present invention;

FIG. 5 is a schematic diagram of joining and bonding adjacent panels together through a side edge without having its corners chamfered according to yet another embodiment of the present invention;

FIG. 6 is a schematic diagram of joining and bonding adjacent panels together through side edges with their corners chamfered according to still yet another embodiment of the present invention; and

FIG. 7 is a schematic diagram of assembled panel formed by overlapping a plurality of panels having their side edge corners chamfered according to still yet another embodiment of the present invention.

### DETAILED DESCRIPTION OF THE PREFERRED EMBODIMENT

The purpose, construction, features, and functions of the present invention can be appreciated and understood more thoroughly through the following detailed description with reference to the attached drawings.

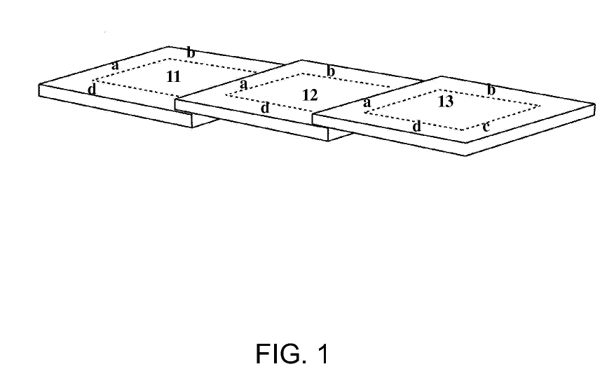

Please refer to FIG. 1, which is a perspective view of overlapping of liquid crystal panels with their side edges according to an embodiment of the present invention. In this preferred embodiment, the assembled panel of the present invention includes: a liquid crystal panel 11 having four side edges 11a˜11d; a liquid crystal panel 12 having four side edges 12a˜12d; and a liquid crystal panel 13 having four side edges 13a˜13d. In the application of the present invention, a side edge 11c (not shown) of liquid crystal panel 11 is used to overlap side edge 12a of liquid crystal panel 12, so that liquid crystal panel 11 is overlapped with liquid crystal panel 12 to form into an assembled liquid crystal panel. Similarly, a side edge 12c (not shown) of liquid crystal panel 12 is used to overlap side edge 13a of liquid crystal panel 13.

Compared with the simple side-by-side assembled liquid crystal panel, the liquid crystal panel bonded by means of side edge overlapping may save half of the gap at most, namely, upon overlapping the side edges of two adjoining unitary panels, the gap between the two panels may be reduced to the width of a frame edge at most, so that the gap seen by a naked eye is reduced significantly. By way of example, for a 26-inch assembled panel, the width of any side edge of a unitary liquid crystal panel is around 8˜9 mm. In case that such liquid crystal panels are assembled directly in a side-by-side manner, then the gap between two adjoining panels can reach as much as two times the width of a side edge (16˜18 mm).

As such, in the application of the method of the present invention, the panel assembly is realized through overlapping the frame edges of the panels by making use of panels of currently available sizes (for example 26-inch and 32-inch, etc.), so that not only the display area can be increased, but the gap between the display areas incurred by the non-display area can also evidently reduced, hereby achieving an almost seamless large sized panel.

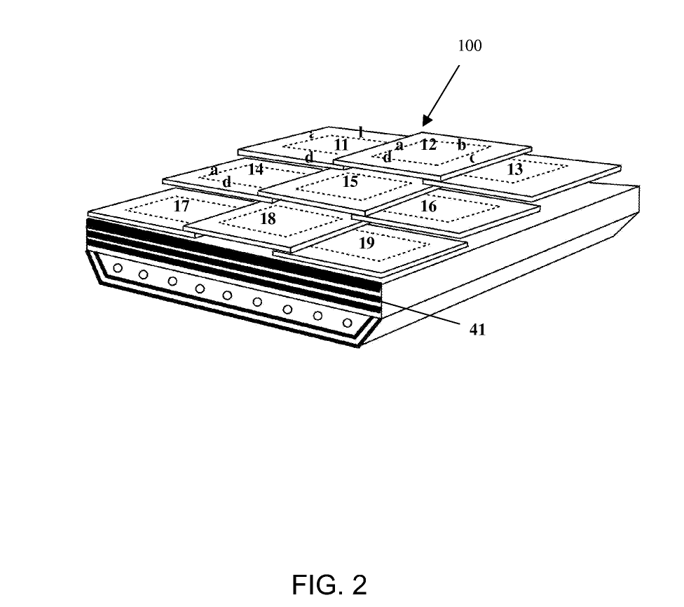

Please Refer to FIG. 2, which is a schematic diagram of a display having assembled panels according to an embodiment of the present invention. In this case, the liquid crystal panel 11 is taken as an example. Wherein, a side edge 11c (not shown) of liquid crystal panel 11 is used to overlap the side edge 12a of an adjoining liquid crystal panel 12 in a horizontal direction; or, alternatively, a side edge 11d of liquid crystal panel 11 is used to overlap the side edge 14b (not shown) of an adjoining liquid crystal panel 14 in a longitudinal direction, thus achieving the purpose of bonding two adjoining panels. Upon further integrating the assembled panel made of liquid crystal panels 11-19, an over-covered protection layer 31 (not shown), and an outside attached backlight module 41, thus forming a display 100.

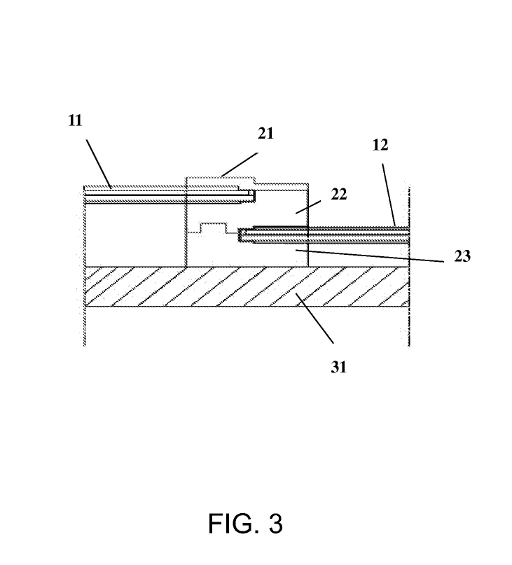

Please refer to FIG. 3, which is a cross section view indicating the locking and bonding of two adjacent overlapping panels. In this embodiment, a locking piece 23 is placed upon a protection layer 31, wherein, locking pieces 23 and 22 are disposed on the lower surface and upper surface of liquid crystal panel 12, while locking pieces 22 and 21 are disposed on the lower surface and upper surface of liquid crystal panel 11. Then, the locking and bonding members (such as screws, not shown) are utilized to secure the frame-edge-overlapped liquid crystal panel 11 and liquid crystal panel 12.

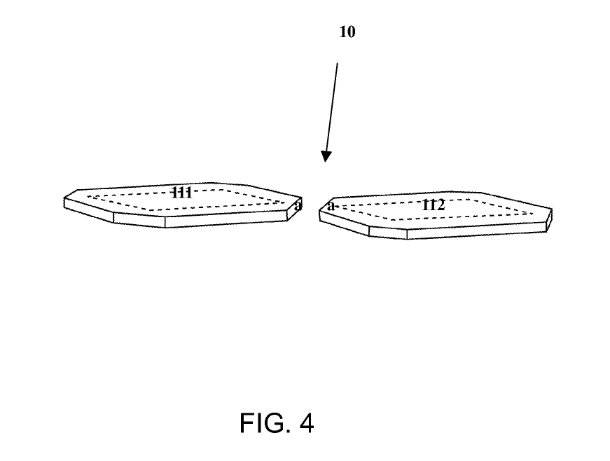

In a further preferred embodiment, the present invention discloses a large-sized panel assembly method, in which side edge corners of liquid crystal panel are chamfered to reduce the section difference of the overlapped panels. As mentioned previously, in case that each of the respective side edges of a panel is overlapped with that of another panel to reduce the gap between adjacent panels. In this case, since each of the respective panels is located on a different plane, thus the section difference for assembled panel may be overly large. In order to further solve this problem so as to minimize the section difference between adjacent panels and thus the section difference for the entire assembled panel, precision instrument or professional cutting machine can be used to cut the side edge corners of the respective panels. Please refer to FIG. 4, which is a schematic diagram of joining and bonding adjacent panels through side edges of chamfered corner according to another embodiment of the present invention. Wherein, a side edge corner is chamfered respectively for the 32-inch liquid crystal panel 111 and liquid crystal panel 112, to form the fifth side edges 111a and 112a respectively. Then the two side edges are moved to contact and bond each other, thus forming an assembled panel 10. In the case of assembling panels having a plurality of chamfered corners, the adjacent panels are overlapped with each other through frame edges to form upper and lower interleaving arrangements. Meanwhile, panels in the same plane and having their corners chamfered are able to be assembled to each other without creating section differences.

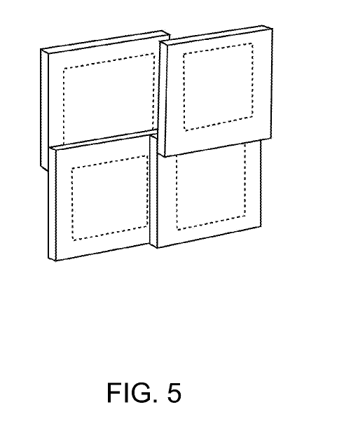

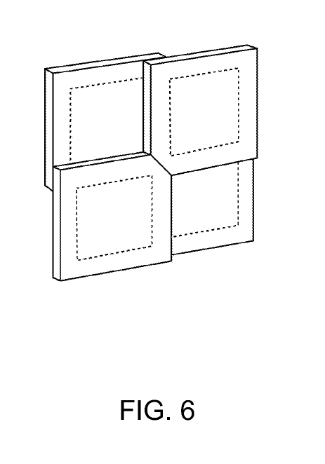

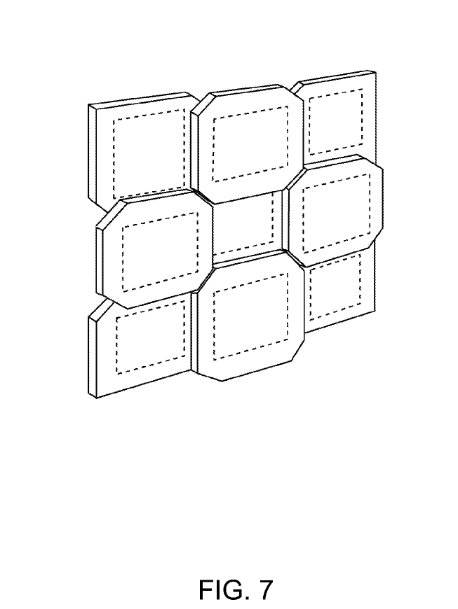

In this case, a panel of minimum unit formed by four panels through overlapping their edges is taken as example for explanation. Thus, for the case before the side edge corners are chamfered, the side edges of the other 3 panels are overlapped on the side edges of a bottom panel. In this structure, neglecting the thickness of the bottom panel, then for an assembled panel formed simply by overlapping the side edges of four single unitary panels, the section difference is the thickness of 3 panels (around 9 mm) (refer to FIG. 5). However, in case that the panel assembly method for panel having their side edge corners chamfered of the present invention is utilized, then, since some of the panels having their side edge corners chamfered are connected and bonded in the same plane, while the other panels having their side edge corners chamfered and overlapped on the side edges of respective panels just mentioned are in another plane, in this up-and-down interleaving structure of assembled panel, the maximum section difference is merely the thickness of a single panel (around 3 mm) (refer to FIG. 6). In this case, even if increasing the number of panels to proceed with the panel assembly for an even larger size, then the maximum section difference for the assembled panel obtained through side edge overlapping is merely the thickness of a single panel (refer to FIG. 7), as such, improving significantly the image display quality and effect for large-sized display. Of course, for different display application, or in case that the gap (on the edge of display area) problem is not a major concern, then the side edge overlapping or side-by-side alignment method can be utilized alternatively, hereby achieving the maximum effectiveness of the panel assembly method of the present invention.

In the application of the panel assembly method of the present invention, side edges are utilized for overlapping panels, so that the gaps formed by side edges can be decreased to one half of the original width. Furthermore, the corners of side edges are chamfered, so that the section difference of the adjacent panels after assembly is approximately the thickness of an LC panel only, as such, creating visually an almost seamless image display surface without section difference. In addition, the part after side edge corner is chamfered is still a part of the side edge, thus the sealing glue for the main body of LC panel is not damaged, and liquid crystal is in no danger of leaking out, as such realizing the safe and secure panel assembly method with remarkable benefits and advantages.

The above detailed description of the preferred embodiment is intended to describe more clearly the characteristics and spirit of the present invention. However, the preferred embodiments disclosed above are not intended to be any restrictions to the scope of the present invention. Conversely, its purpose is to include the various changes and equivalent arrangements which are within the scope of the appended claims.

What is claimed is:

1. A liquid crystal display (LCD) panel assembling method, comprising the following steps:
preparing a plurality of unitary LCD panels; and
aligning or overlapping any one side edge of a unitary LCD panel with any one side edge of another unitary LCD panel, thus forming an assembled LCD panel having smaller gaps.

2. The liquid crystal display (LCD) panel assembling method as claimed in claim 1, wherein said unitary LCD panel is used to overlap another unitary LCD panel laterally or longitudinally.

3. The liquid crystal display (LCD) panel assembling method as claimed in claim 1, wherein said unitary LCD panel is used to align with another unitary LCD panel laterally or longitudinally.

4. The liquid crystal display (LCD) panel assembling method as claimed in claim 1, wherein said assembled LCD panel is realized through joining and bonding said overlapped or aligned liquid crystal panels together by making use of at least a locking and holding member.

5. A display, comprising:
a plurality of unitary LCD panels;
a plurality of pixel elements; and
a backlight module;
wherein, the respective unitary LCD panel includes a display area and a non-display area composed of a plurality of side edges, said any one side edge of said unitary LCD panel is aligned or overlapped with any one side edge of another unitary LCD panel, hereby forming an assembled LCD panel having larger display area and smaller gaps in-between.

6. The display as claimed in claim 5, wherein said liquid crystal panel is used to overlap another unitary liquid crystal panel laterally or longitudinally.

7. The display as claimed in claim 5, wherein said liquid crystal panel is used to align with another unitary liquid crystal panel laterally or longitudinally.

8. The display as claimed in claim 5, wherein said assembled liquid crystal panel is realized through joining and bonding the overlapped or aligned liquid crystal panel together by making use of at least a locking and holding member.

9. A liquid crystal display (LCD) panel assembling method, comprising the following steps:
preparing a plurality of unitary LCD panels;
chamfering their side edge corners; and
aligning or overlapping any one side edge of a unitary LCD panel with any one side edge of another unitary LCD panel, thus forming an assembled LCD panel having smaller gaps and/or smaller section differences.

10. The liquid crystal display (LCD) panel assembling method as claimed in claim 9, wherein said liquid crystal panel is used to overlap another unitary liquid crystal panel laterally or longitudinally.

11. The liquid crystal display (LCD) panel assembling method as claimed in claim 9, wherein said liquid crystal panel is used to align with another unitary liquid crystal panel laterally or longitudinally.

12. The liquid crystal display (LCD) panel assembling method as claimed in claim 9, wherein said assembled liquid crystal panel is realized through joining and bonding the overlapped or aligned liquid crystal panel together by making use of at least a locking and holding member.

13. A display, comprising:
a plurality of unitary LCD panels;
a plurality of pixel elements; and
a backlight module;
wherein, the respective unitary LCD panel includes a display area and a non-display area having a plurality of side edges, and the corners of the side edges of said unitary liquid crystal display panel have been chamfered, any one side edge of the unitary LCD panel is aligned or overlapped with any one side edge of another unitary LCD panel, thus forming an assembled LCD panel having smaller gaps and/or smaller section differences.

14. The display as claimed in claim 13, wherein said unitary LCD panel is used to overlap another unitary LCD panel laterally or longitudinally.

15. The display as claimed in claim 13, wherein said unitary LCD panel is used to align with another unitary LCD panel laterally or longitudinally.

16. The display as claimed in claim 13, wherein said assembled LCD panel is realized through joining and bonding said overlapped or aligned liquid crystal panels together by making use of at least a locking and holding member.
